(19) United States
(12) Patent Application Publication
(10) Pub. No.: US 2025/0200970 A1
(43) Pub. Date: Jun. 19, 2025

(54) Aggregating and/or Personalizing Camera Feeds

(71) Applicant: Comcast Cable Communications, LLC, Philadelphia, PA (US)

(72) Inventor: Lawrence Reeve, Sewell, NJ (US)

(21) Appl. No.: 18/540,508

(22) Filed: Dec. 14, 2023

(51) Int. Cl. G06V 20/40; G06F 16/735; G06F 16/74; G06F 16/75; G06V 10/94; G06V 20/52; H04N 7/18

(52) U.S. Cl. CPC G06V 20/46; G06F 16/735; G06F 16/743; G06F 16/75; G06V 10/945; G06V 20/52; H04N 7/183

(57) ABSTRACT

Systems, apparatuses, and methods are described for aggregating and/or personalizing video feeds for users of a system that comprises multiple video capture devices (e.g., home security system cameras). A user's interactions with video clips may be analyzed to build a personalized relevancy model (e.g., a scoring model). Video clips from a plurality of cameras may be aggregated and assigned with relevancy scores based on the relevancy model. Scored video clips may be ranked and presented to the user in an order that presents the most relevant video clips first.

### BACKGROUND

A camera (e.g., a security camera) may generate hundreds of motion-related video clips in a day. For example, a home may have several security cameras located at different positions around a house. The number of video clips may become overwhelming to a user who is reviewing the motion activity generated by one or more cameras. Also, the video clips are usually presented in a chronological or reverse chronological order by individual camera. A user may need to browse for a considerable amount of time before he or she sees something relevant or interesting, and will typically need to navigate between individual cameras to review all video clips. These and other shortcomings are identified and addressed in the disclosure.

### SUMMARY

The following summary presents a simplified summary of certain features. The summary is not an extensive overview and is not intended to identify key or critical elements.

Systems, apparatuses, and methods are described for aggregating and/or personalizing camera feeds for users of a camera system (e.g., home security system). A user's interactions and patterns of selecting and viewing camera system video clips (e.g., selected cameras, objects of interest, proximity of objects, part of day, etc.) may be analyzed, and a personalized relevancy model (e.g., a scoring model) may be built based on an analysis result. Video clips (or video segments) from all cameras may be aggregated and assigned with relevancy scores based on the relevancy model. The scored video clips may be ranked and presented (e.g., fed) to a user in an order that the most relevant video clips may be presented first. For example, a user's access or interaction with a video clip may show a considerable interest in video clips from a particular camera, e.g., a backdoor camera, and at a particular time, e.g., at night time, and related to certain objects, e.g., animal activities. The backdoor camera, night time, and animal may be given considerable weights in the relevancy model. And video clips that involve these characteristics may be presented to the user with priority. This may bring an improved user experience that may not be available with existing security camera systems. A user may be able to focus on the security video clips that are most relevant to the user, without spending time and effort to browse through a considerable amount of irrelevant video clips.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2 shows hardware elements of a computing device.

FIG. 3A shows an example of extracting characteristics from video clips.

FIG. 3B shows an example statistical table with weights, based on video clips played back by a user.

FIG. 3C shows an example of calculating relevancy scores.

FIG. 3D shows an example statistical table with adjusted weights.

FIG. 3E shows an example of adjusted relevancy scores.

FIG. 4A and FIG. 4B are a flow chart showing an example method for personalizing the priority and/or arrangement of aggregated video clips based on video clips played back by a user and user feedback.

FIG. 5 shows an example of aggregated and personalized presentation for camera feeds of a plurality of video cameras.

FIG. 6 shows another example of aggregated and personalized presentation for camera feeds of a plurality of video cameras.

FIG. 7A and FIG. 7B show an example map of a premises with clickable icons for camera feeds.

FIG. 8A shows an example of personalized presentation for a camera feed.

FIG. 8B shows an example of reordering the presentation by a user.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

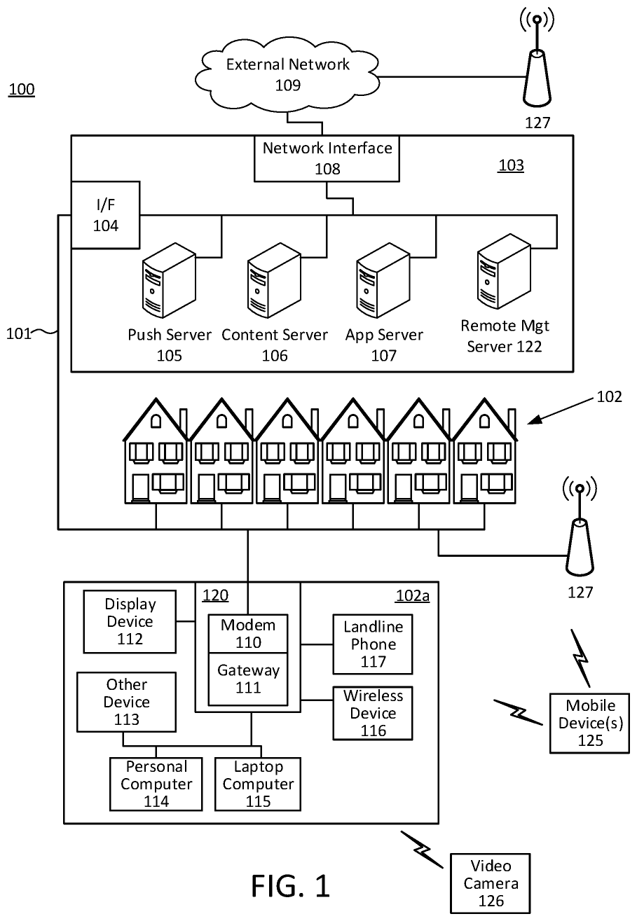

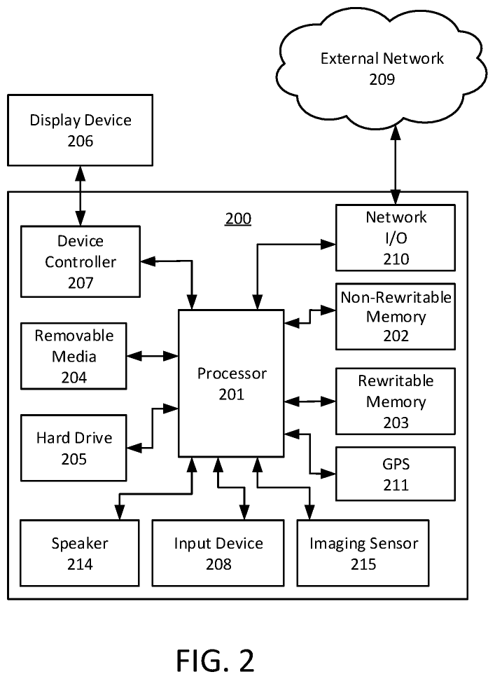

FIG. 1 and/or FIG. 2 show examples of elements that can perform operations described in later figures. FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102a (e.g., businesses, homes, consumer dwellings, train stations, airports, etc.) to a local office 103 (e.g., a headend). The local office 103 may send downstream information signals and receive upstream information signals via the communication links 101. Each of the premises 102a may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107 and 122, and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102a and/or to the mobile devices 125. The content server 106 may be configured to provide content to devices in the premises 102a and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102a and/or to the mobile devices 125. The local office 103 may comprise additional servers, such as the remote management (“Mgt”) server 122 (described below), additional push, content, and/or application servers, and/or other types of servers. The remote management server 122 may be configured to manage devices in the premises 102a, for example, video cameras and cameras feeds associated with the video cameras. Operations of the remote management server 122 may also or alternatively be performed by a computing device in the premises 102a with which one or more video cameras 126 (will be described below) communicate, and/or by a computing device that incorporates one or more video cameras 126. Although shown separately, the push server 105, the content server 106, the application server 107, the remote management server 122, and/or other server(s) may be combined. The servers 105, 106, 107, and 122, and/or other servers, may be computing devices and may comprise memory storing data and also storing computer executable instructions that, when executed by one or more processors, cause the server(s) to perform steps described herein. The local office 103 may comprise additional servers, such as additional push, content, application, and/or management servers, and/or other types of servers. Also or alternatively, one or more servers (e.g., a server such as the remote management server 122) may be part of the external network 109 and may be configured to communicate (e.g., via the local office 103) with computing devices located in or otherwise associated with one or more premises 102a.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA)), landline phones 117 (e.g., Voice over Internet Protocol—VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on- or off-premises. A plurality of video cameras 126, or other security device, may be installed for monitoring the premises 102a, and may communicate with remote management server 122 to, for example, provide uploads of video clips captured by the plurality of video cameras 126. The plurality of video cameras 126 may communicate with the remote management server 122 and/or other external computing devices via the interface 120 and/or via another computing device in premises 102a. The video camera 126 may be a wireless device 116. The video camera 126 may be part of a security system. The video camera 126 may be part of a multi-functional device such as a video doorbell. The video camera 126 may be configured to take pictures and/or videos in the day time and night time. The video camera 126 may be configured to start taking pictures and/or videos, for example, based on detection of motion.

The mobile devices 125, one or more of the devices in the premises 102a, and/or other devices may receive, store, output, and/or otherwise use assets. An asset may comprise a video, a game, one or more images, software, audio, text, webpage(s), and/or other content.

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices with the external network 109) and any other computing devices discussed herein (e.g., video camera 126). The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200. The computing device 200 may (e.g., if the computing device 200 is used to implement the video camera 126) comprise an imaging sensor 215 (e.g., a charge-coupled device (CCD) or a complementary metal oxide semiconductor (CMOS)) to capture images and/or video.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

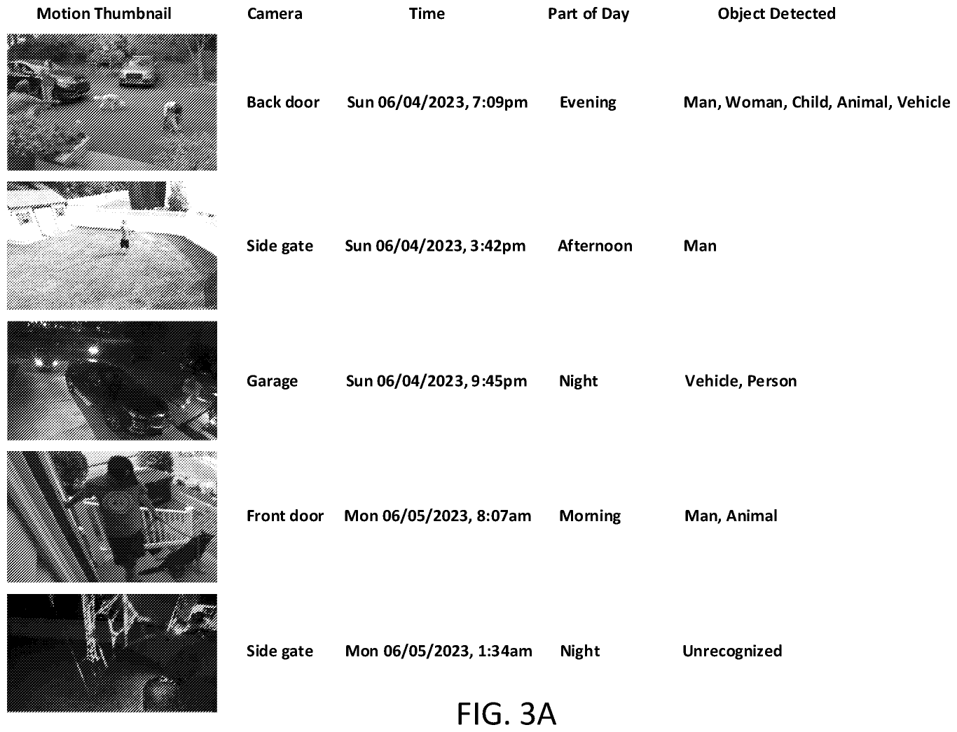

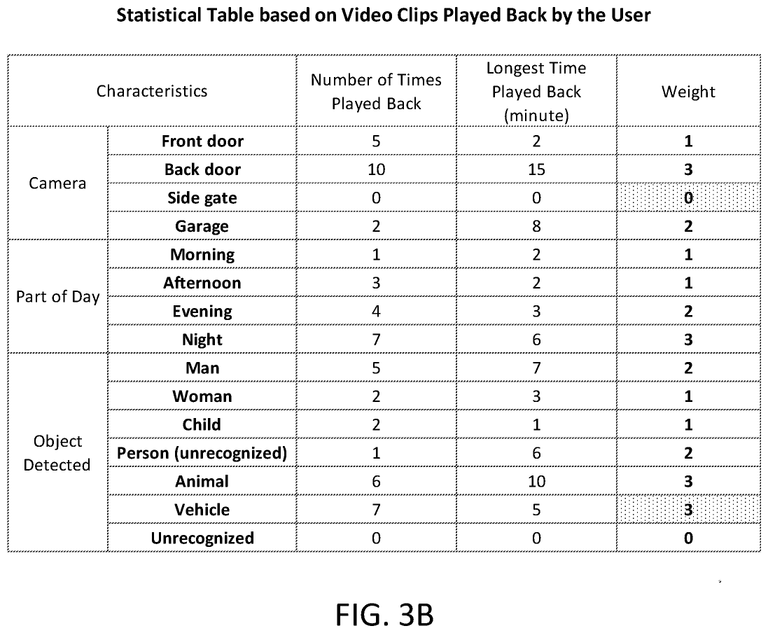

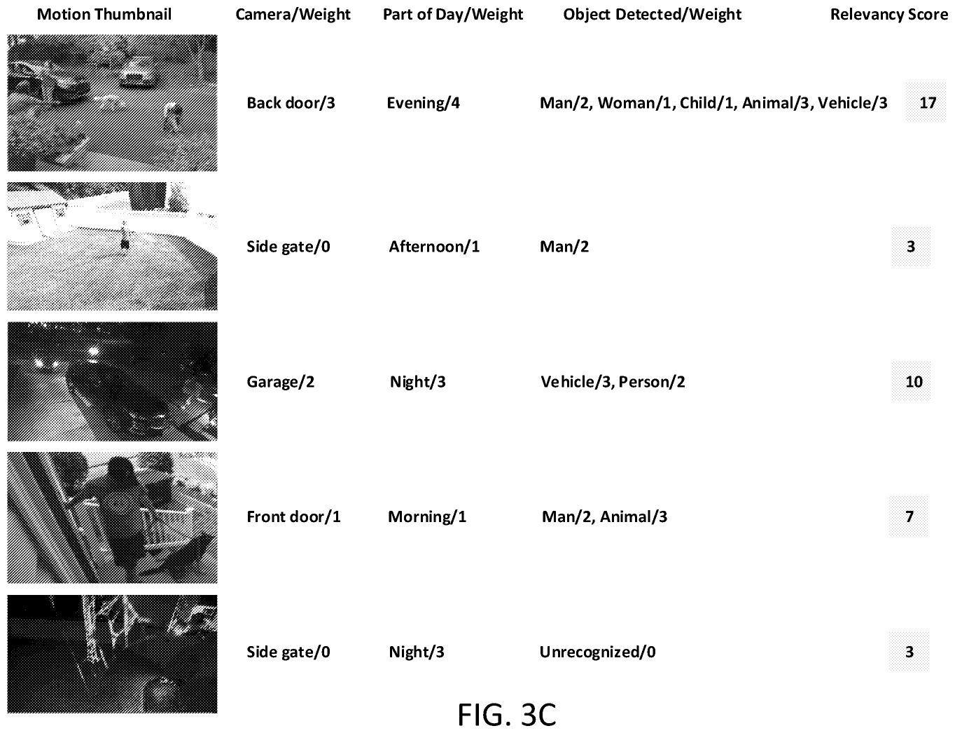

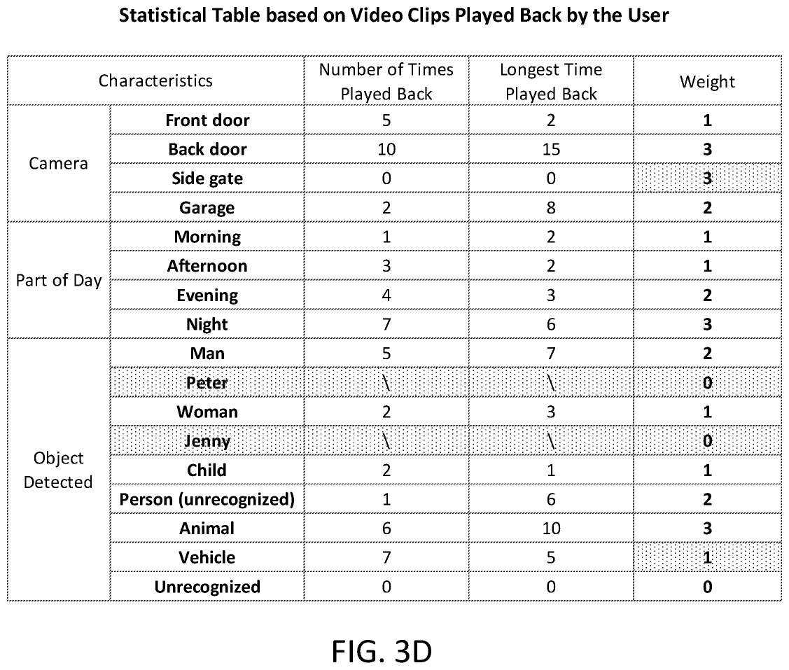

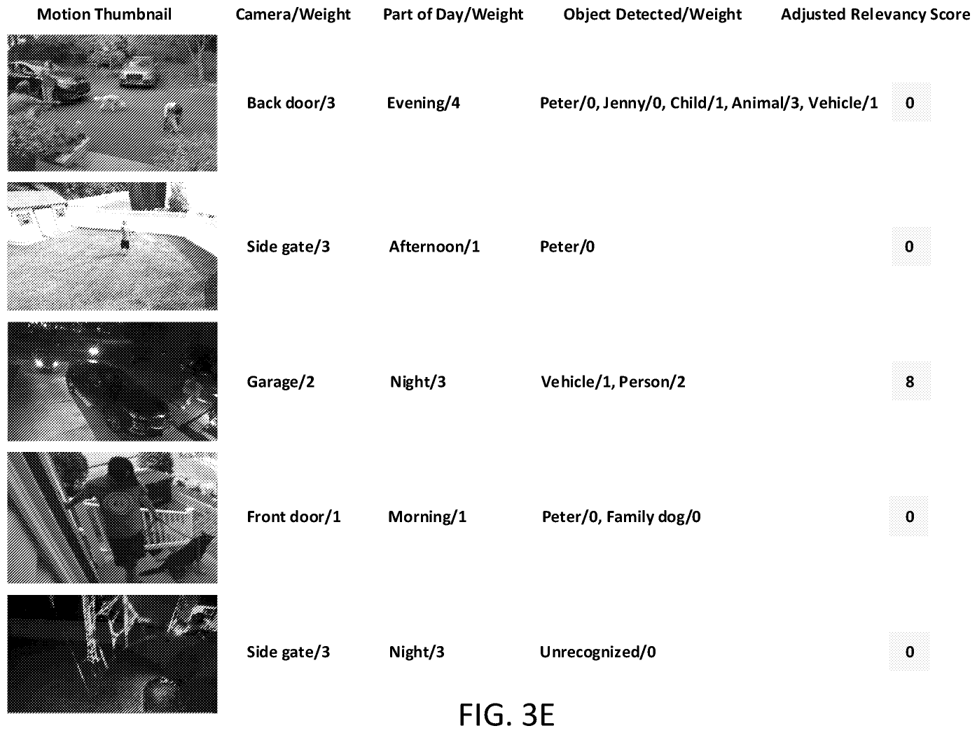

FIG. 3A-FIG. 3E show an example of generating personalized relevancy scores for video clips (or video segments) from more than one camera of a camera system. The camera system may be any camera system that may involve individual interests or preferences. The camera system may, for example, comprise one or more cameras such as the video camera 126 of FIG. 1. For example, the camera system may be at least part of a home security system with video cameras. For example, the camera system may be incorporated in other systems or devices such as smart doorbells. The camera system may be connected (wired or wirelessly) to a network, and the video clips may be transmitted, uploaded, and/or otherwise sent to a computing device (e.g., the remote management server 122) for processing, analyzing, etc. The computing device may store video clips in memory devices (e.g., the non-rewritable memory 202). The computing device may send video clips to one or more users for viewing, on demand or on a predetermined schedule or condition (e.g., daily, weekly, if the number of highly relevant video clips exceeding a threshold, etc.). The computing device may take various forms. For example, operations performed by the remote management server 122 may alternatively or also be performed by the video camera 126 or by other computing device(s) in the same premises.

These video clips may comprise video clips that are more relevant and/or interesting to one or more users and video clips that are less relevant and/or interesting to one or more users. For example, these video clips may be presented in an order and/or format that more relevant video clips may be prioritized in the presentation (e.g., presented first, presented with an indication of priority). For example, the least relevant or interesting video clips may be located near an end of a list of video clips, may be inconspicuous, or may be hidden or not presented to the user(s) at all. For example, the video clips may be selected, arranged, and/or ranked based on relevancy scores of the video clips. A relevancy score may indicate how much a video clip is relevant and/or interesting to an individual user. For example, if a user is interested in a video clip, he or she may choose to play that video clip, may watch that video clip for a considerable time, may pause in the middle, and/or may replay that video clip for repeated watching. For example, if a user is not interested in a video clip, he or she may choose not to play that video clip, may stop playing that video clip after a short time (e.g., no more than a few seconds), might not pause, and/or might not replay that video clip.

These user behaviors with respect to the video clips may be recorded and/or used to build an algorithm for calculating relevancy scores. For example, characteristics (e.g., camera ID, part of day, objects detected, etc.) of the video clips that the user showed more interest in may be obtained and given higher weights (or degrees of importance), while characteristics of the video clips that the user showed less or no interest in may be obtained and given lower weights or zero weight. The more often the user showed interest in a characteristic, the higher the weight of that characteristic may be. For example, a user may have played video clips from a back door camera 10 times more than video clips from a garage camera in the recent week. This may support the back door camera having a higher weight than the garage camera does. For another example, a user may have watched a video clip with an animal (e.g., with no other object) in it for 10 minutes recently. This may show the user's interest in the object being animal and thus may support this characteristic having a relatively high weight. Part or all of these characteristics may be obtained (e.g., extracted) from video clips that have not been presented to the user before, and the weights of these characteristics may be used to calculate (e.g., sum) a relevancy score for each of the video clips. As a result, the video clips may be sorted in an order based on relevancy to the user, and the most relevant video clips may be presented to the user first and/or in a more noticeable way. This may save the user much time by directing his or her attention to the more relevant or interesting video clips. To simplify the description, examples in this specification may focus on one or two of the behaviors for building an algorithm. However, those skilled in the art may, in view of the disclosure herein, replace, change, and/or add behaviors that are related to user interest and reflect them in the algorithm.

The relevancy scores may be in the forms of numerical numbers (e.g., positive integers), levels (e.g., high, medium, low), and/or any other form that is appropriate. The relevancy scores may reflect a personalized view of a collection of video clips for an individual user. The individual user may be one or more people. For example, the individual user may be one or more members of a family that use a camera security system. For example, the individual user may be a repeat user of the video clips, so that his or her past behavior with respect to the video clips may affect the selection and/or presentation of the video clips in the future and thus improve his or her user experience. If there are several users, the relevancy scores may reflect a combined interest of these users. In general, the fewer the users, and/or the more common interests of the users, the more the user experience may be improved. Also or alternatively, a process (e.g., calculating relevancy scores) could, for a set of video clips, be separately performed for each of a plurality of individual users, and video clips in the set may be ordered and/or sorted etc., differently for each user.

FIG. 3A shows an example of extracting characteristics from video clips. In FIG. 3A, there is an example table showing columns including motion thumbnail, camera, time, part of day, and object detected. In the motion thumbnail column, there are five example thumbnails of video clips. The thumbnails show different camera perspectives, different objects, and different lighting which may suggest different time of a day. One or more frames (or images) of the video clips represented by the thumbnails may be processed to perform feature recognition of the objects (people, animals, vehicles, delivery, etc.), facial recognition of people, recognition of text such as license plate numbers of vehicles, motion detection, and/or any other desired form of video processing. Similarly, audio processing may be used for the video clips to recognize voices of people, detect audio disturbances such as sirens and alarms, and/or any other desired form of audio processing. The image/audio processing may be implemented locally at the video camera 126, at the gateway 111, remotely at the remote management server 122, or at any desired location. The frames of the video clips may be compressed, have duplicate frames removed, or otherwise processed to reduce size for storage and/or transfer.

Video generation characteristics including camera ID, camera location (e.g., if not already correlated to camera ID), time, part of day, etc. may be obtained for each of the video clips. For example, the first thumbnail from the top may be captured by a video camera 126 at the back door of a premises on 7:09 pm, Sunday Jun. 4, 2023. The camera ID (e.g., Back door) and the time may be obtained in various ways depending on the video format. For example, a video clip file may have metadata that may comprise details about the camera and the date and time of recording. The metadata may be obtained by checking the file's properties or using software that may display metadata. Part of day may be generated based on the date and time information. For example, 5 am to noon may be considered as Morning; noon to 5 pm may be considered as Afternoon; 5 pm to 9 pm may be considered as Evening; and 9 μm to 4 am may be considered as Night. The determination of part of the day may be customized for the user based on their geographic location (e.g., time zone), time of the year, and/or personal preferences. The video generation characteristics may also be referred to as characteristics associated with selection (or output) of a plurality of video segments.

Video characteristics including object detected, length of the video (not shown), etc. may be obtained for each of the video clips. The object may include one or more objects. The object detected may comprise categories of motion entities in the content, such as man, woman, animal, vehicle, delivery, etc., These categories may comprise different levels of categories. For example, a category “man” may have a deeper-level category (or subcategory) “Peter”, and/or may have a higher-level category “person”. The object detected (e.g., categories of motion entities) may be obtained (e.g., recognized) from the content of a video clip. For example, one or more frames of the video clip represented by the second thumbnail from the top may be processed and a man may be recognized to be the object of interest in the video clip. For another example, for the first thumbnail from the bottom, there may be a spider and its web in the video clip. However, a video processing software may recognize no object of interest, for example, due to unclear shapes and/or the spider not being registered in the software. Video processing technologies to detect and recognize objects are well known and will not be described herein in detail. Video characteristics may also include proximity of detected objects to a camera. The proximity may serve as a parameter for determining relevancy of a video clip. For example, the more proximate an object is to a camera, the more impact the object might have on a premises where the camera is, and/or the more detail a user may see about the object. More impact and/or more detail may lead to higher relevancy of a video clip. Video characteristics may also include direction of movement for detected objects. For example, several frames of a video clip may be analyzed to see if a person is leaving or arriving at a premises. The direction may be considered in determining relevancy of a video clip. The video characteristics may also be referred to as characteristics associated with content of a plurality of video segments.

FIG. 3B shows an example statistical table with weights of various characteristics in a video clip, based on video clips played back by a user. Video clips that have been selected and played back by a user in a past period of time (e.g., during a recent month or week) may be collected and analyzed for user's interest. Various characteristics may be obtained from the video clips. The characteristics may comprise video generation characteristics (e.g., camera ID, time, part of day, etc.) and video characteristics (e.g., object detected, length of the video, proximity of object to camera, etc.) as described above. Statistical data of these characteristics may be obtained to gain insight on the user's interest. For example, the more frequent or for the bigger number of times that a characteristic appears in played back video clips, the more interest a user might have for that characteristic. For another example, the longer the user watches a video clip, the more interest the user might have for the video clip and related characteristics. The frequencies or numbers of times and the length of playing back may be collected as at least part of the statistical data. These data may be processed (e.g., ranked, averaged, finding the total, finding the maximum, etc.) to help with generating weights which are an example that quantifies user's interest. For example, for characteristics of a same type, weights may be assigned to each characteristic by ranking. For example, out of 20 video clips played back by the user in a week, 5 may be from a front door camera, 10 may be from a back door camera, 0 may be from a side gate camera, and 2 may be from a garage camera. The ranking for the cameras may be Back door>Front door>Garage>Side gate. As the user's interest for the side gate camera seems to be zero, 3 may be used as the biggest weight, and the weights for the cameras may be Back door (3)>Front door (2)>Garage (1)>Side gate (0). In addition, the length of time played back may be considered. For example, a longest time played back for each characteristics may be considered. According to the example in FIG. 3B, the ranking for the cameras based on longest time played back is Back door>Garage>Front door>Side gate. The order of the front door camera and the garage camera has been changed. The numbers (e.g., number of times, longest time) in the table related to camera may show that, although video clips from the front door camera have been played more often, the user might have merely taken a quick look at each video clip from the front door camera, as shown by the longest time being 2 minutes. A quick look may be an indication of quick judgment, which may indicate a normal or uninteresting situation for the user. On the other hand, the longest playback time of the 2 video clips from the garage camera may be 8 minutes, which may show a prolonged look at one of the video clips. The prolonged look may show a special attention from the user, which may indicate a special interest or concern from the user. Thus, the weights for the cameras may be adjusted to Back door (3)>Garage (2)>Front door (1)>Side gate (0), based on the order of the longest time played back. Other characteristics may be ranked and/or assigned weights in a similar manner. For example, for the characteristics under object detected, out of 20 video clips played back by the user in a week, there may be different numbers of times played back for different objects. For example, 5 video clips that have been played back may comprise Man, 2 may comprise Woman, etc. as shown in FIG. 3B. Moreover, each object may have a respective longest time played back for their video clips. Ranking may be performed, for example, based on the number of times played back and longest time played back. For example, the objects may be ranked as Vehicle>Animal>Man>Woman=Child>Person (unrecognized)>Unrecognized, based on number of times played back. The order may be Animal>Man>Person (unrecognized)>Vehicle>Woman>Child>Unrecognized, based on the longest time played back. The weights for the objects may be assigned as Animal (3)=Vehicle (3)>Man (2)=Person (unrecognized) (2)>Woman (1)=Child (1)>Unrecognized (0), based on both rankings, for example, if the biggest weight is set to be 3. An algorithm may be designed to calculate the weights based on the rankings and/or on the absolute numbers which are the basis for the ranking. The algorithm may find a balance among the rankings and differences between numbers that may reflect the user's interest most accurately. For example, Animal and Vehicle swamp orders in the two rankings and seem to have equal weights overall. However, the algorithm may still give Animal a higher priority in showing its video clips, as the longest time played back for Animal is much longer than that for Vehicle (with a difference of 5 minutes), compared to the difference in number of times played back (1 time). For example, the algorithm may automatically provide weights to characteristics based on user's past interactions with video clips. The algorithm may use artificial intelligence (AI) and/or machine learning (ML) to dynamically learn from playback records of video clips and make determinations on weight assignments. The algorithm may be dynamically adjusted, for example, based on new behaviors of user and/or user feedback. The weight for each characteristic may be derived dynamically, over a predetermined number of repetitions of user behavior, and/or by explicit desire by the user to weight certain characteristics higher than other characteristics.

In the example table in FIG. 3B, there are example cells (indicated with stippling) which may indicate that these characteristic weightings may be changed by the user and/or automatically later. Any of the weight cells may be changeable cells. For example, a user may review the weights and/or results of the weights, and may change the weights and/or provide feedback that may change the weights. For example, the algorithm may be adjusted to calculate different weights, for example, based on a user's feedback. For example, in FIG. 3B, the side gate camera may have zero video clips played back in a recent week. However, the user may newly develop an interest in the side gate area and may want to see more videos from there. For example, the user may find out that the side gate has a damaged part that might be caused by animal biting. Accordingly, a weight for the side gate camera may be increased to reflect that interest. The weight for Animal may be adjusted as well, for example, if the weight does not reflect a higher priority. For another example, the object Vehicle may have a high weight due to the vehicle appearing in the most video clips played back and a relatively long playback time of at least one of these video clips. However, the user may consider Vehicle less interesting, and he or she may have been more interested in a person and/or an animal that was in a vicinity of the Vehicle when he or she played back the video clips. The user may reduce the weight of Vehicle, for example, by manually revising the weight value. For example, the Unrecognized may be a spider and web and may be not interesting to a user. A user may increase the weight of Unrecognized, for example, if the Unrecognized may be something that interests the user (e.g., an unidentified flying object). Examples of the adjusted weights may be shown in FIG. 3D as will be described below.

FIG. 3C shows an example of calculating relevancy scores. FIG. 3C may use the example in FIG. 3A to show weights applied to each characteristic and corresponding relevancy scores. Weights obtained based on statistical data of past played back video clips may be used to build a scoring model (or relevancy model) that may be used to score relevancy for video clips. For example, each characteristic of a video clip may be assigned a weight based on the scoring model. A relevancy score of the video clip may be calculated, for example, based on weights of all characteristics. For example, in FIG. 3C, each characteristic of each category (e.g., camera, part of day, object detected) may be assigned a weight, and a relevancy score may be calculated based on the weights. For example, for the first motion thumbnail, the camera characteristic Back door may have a weight of 3, the part of day characteristic Evening may have a weight of 4, and the object characteristics may have the following weights: 2 for Man, 1 for Woman, 1 for Child, 3 for Animal, and 3 for Vehicle. A total of these weights may be 17 (3+4+2+1+1+3+3), which is shown as the relevancy score. For another example, for the second motion thumbnail, the camera characteristic Side gate may have zero weight, the part of day characteristic Afternoon may have a weight of 1, and the object characteristic Man may have a weight of 2. The total weights may be 3 (1+2), which is shown as the relevancy score. The relevancy scores may be temporary and/or may be adjusted. For example, if there are multiple categories of objects detected in a video clip (e.g., a man, a woman, a child, a pet, a vehicle, etc.), this video clip might not be interesting (e.g., concerning) or relevant for at least some users, and the relevancy score may be reduced or at least be less than a sum of weights for all the objects. The relevancy score may be adjusted, for example, if one or more weights are changed based on user's feedback. The relevancy score may be adjusted (e.g., reduced), for example, if a video clip is considered as a duplicate and/or similar one of another video clip, and/or if a video clip has been seen by a user previously.

FIG. 3D shows an example statistical table with adjusted weights. Weights may be adjusted to be consistent with user's interest that may not be accurately reflected by past statistical data and/or that may be changed. For example, in a situation where a played back video clip comprises more than one detected objects (e.g., Man, Vehicle), it may be difficult to tell from statistical data if a user is interested in some or all of the detected objects. For example, a user may newly develop an interest and/or need that has not been shown in the past. Weights may be adjusted based on user's input and/or feedback. For example, the camera characteristic Side gate originally may have a weight of zero (see FIG. 3B), and may be adjusted to 3 (see FIG. 3D), for example, due to a user's new interest. For another example, the object characteristic Vehicle originally may have a weight of 3 (see FIG. 3B), and may be adjusted to 1 (see FIG. 3D), for example, because the user confirmed that he or she is less interested in seeing vehicles in video clips. The weights may be dynamically, regularly, and/or timely adjusted based on user's interest and/or needs.

In FIG. 3D, additional rows highlighted with stippling are examples indicating more detailed detection of objects. For example, more detailed detection and/or recognition of objects may be performed (e.g., by using facial recognition techniques), and deeper-level categories (e.g., subcategories) of characteristics may be generated. For example, a man named Peter may be identified for the object Man. A woman named Jenny may be identified for the object Woman. More detailed detection of objects may further help with prioritizing presentation of video clips that a user is truly interested in. For example, the characteristic Man may have a weight of 2. However, if the man is Peter, who may be the user himself, he may not have any interest in watching a video clip that mainly contains himself. Thus the weight for Peter may be zero. It may be similar for Jenny who may be Peter's wife. It may apply to other family members or people that the user trusts. The same concept may apply to animals or vehicles. For example, if an animal is detected to be a squirrel or a family dog, a user may have less interest, compared to if the animal is a bear or an unknown dog. For example, a family vehicle caught by a garage camera may trigger zero interest of the user, and a stranger vehicle may alert the user that someone might be intruding into his/her property zone. By providing more detailed characteristics of detected objects, more accurate weights may be assigned and more relevant video clips may be identified and presented to the user with priority. For example, a user may take pictures of facial or body features of himself or herself and/or his or her trusted people and/or animals and store them in a database in a facial recognition system related to the cameras. The facial recognition system may use, for example, deep learning and convolutional neural networks (CNNs) for facial recognition. The more detailed characteristics and/or the adjusted weights may be used to calculate a more accurate relevancy score. The more detailed characteristics may be optional and may be applicable, for example, based on camera resolutions, computing capabilities, user's preferences, etc.

FIG. 3E shows an example of adjusted relevancy scores. The relevancy scores may be generated by the scoring model as described above. The scoring model may comprise an algorithm or software that may calculate a relevancy score based on weights of all characteristics of a video clip. For example, the algorithm may comprise summing all weights. The algorithm may comprise one or more parameters and rules that may adjust summed weights to be more consistent with a user's interest. For example, for the first motion thumbnail, a total of all weights may be 12 (3+4+0+0+1+3+1). However, as Peter and Jenny (e.g., the husband and wife who are users) are in the video clip and they have zero weights, they may cause all objects detected to have zero total weight, for example, according to an example algorithm. Moreover, the other characteristics (e.g., camera, part of day) may also have zero weights as a result. Thus, an adjusted relevancy score may be zero. This may be consistent with the user's interest, as video clips containing this couple may suggest nothing dangerous or interesting to the users. The algorithm may change or add rules to improve the calculation. For example, the algorithm may determine that if an unrecognized man is detected besides Peter and Jenny, the weight may be more than zero, for example, 9 (3+4+2). For another example, for the motion thumbnail from the garage camera, there may be a vehicle that is unrecognized (e.g., with an unregistered license number and/or different features of a car) and a person that is also unrecognized (e.g., with unrecognized facial or body features). A relevancy score may be the same as a total weight for all the characteristics of this thumbnail, for example, 8 (2+3+1+2). This relevancy score may enable the video clip to be prioritized in being shown to a user, as the score is higher than other scores in the example of FIG. 3E. The user may have the chance to quickly see this video clip and focus his or her attention on identifying the unrecognized vehicle, person and the situation. Similarly, for the second motion thumbnail, for example, if an unrecognized animal instead of Peter is in the video clip, the relevancy score would be 7 (3+1+3). This score may allow the user to quickly see this video clip as well. As described above, a relevancy score may be adjusted, for example, based on determination that a video clip is a duplicate and/or similar one of another video clip, and/or if a video clip has been seen by a user previously. Although the examples may use a scale of 0-3 to quantify weights, any other scales and/or measurement units may be used. For example, a scale of 0-4, 1-5, negative 3 to positive 3, etc. may be used.

The characteristics as described above may comprise any other characteristics that may be obtained from a video clip and that may help with determining relevancy and/or personalizing priority of the video clip. For example, the characteristics may comprise weather elements (e.g., rain, lightening, etc.). For example, something that happened in bad weather (e.g., thunder storm) may generate more interest (e.g., concern) from a user and may make a video clip more relevant. For example, the characteristics may comprise detected behaviors (e.g., walking, running, climbing, etc.). For example, a video clip with a climbing man may be more interesting (e.g., concerning) for a user than, for example, a walking man. Similarly, the characteristics may comprise detected motions (e.g., tree falling, ground shaking, etc.). The characteristics may comprise directions of movements (e.g., walking out vs. coming in). The detected behaviors of a person or animal, directions of movements, proximity of detected objects (to a camera), etc, may be called derivative categories of motion entities. For example, the characteristics may comprise audio categories (e.g., crying, screaming, barking, gun shot, certain speech, certain phrases, etc.). These audio categories may add useful information to relevancy score calculation. For example, the sound of a gun shot combined with a man in a video clip may greatly increase the relevancy score of this video clip. The quantity and/or combination of characteristics obtained from a video clip may be unlimited.

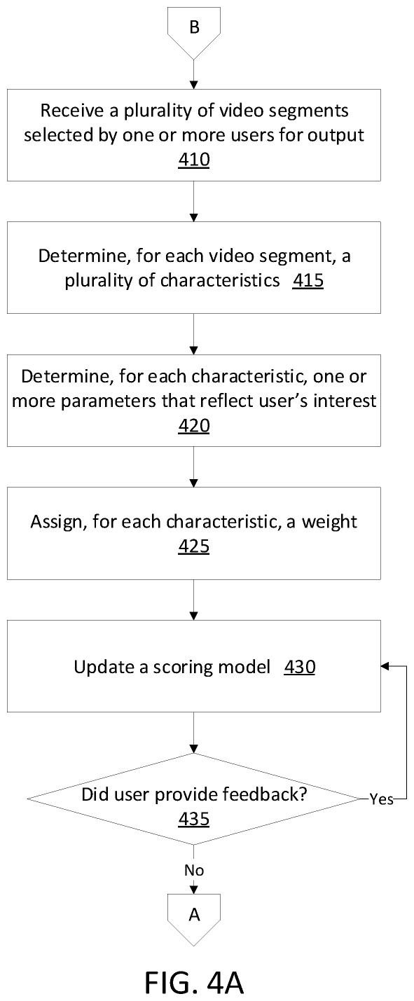

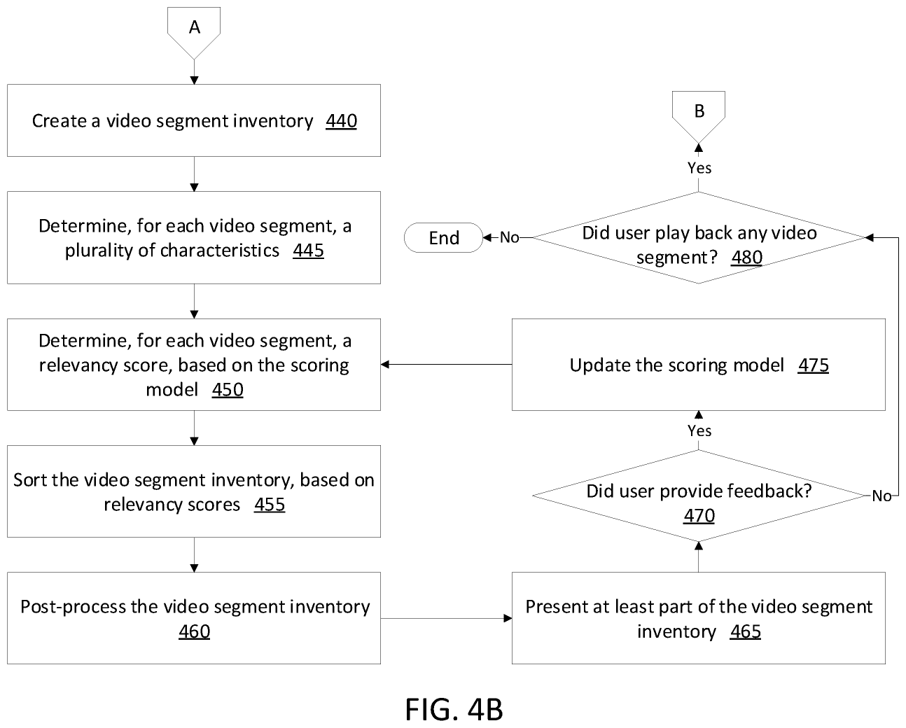

FIG. 4A and FIG. 4B together are a flow chart showing an example method for personalizing the priority and/or arrangement of aggregated video segments (e.g., video clips) based on video segments played back by a user and user feedback. For convenience, the example method of FIGS. 4A-4B is explained below using an example in which steps may be performed by a computing device (e.g., remote management server 122). However, one, some, or all steps of the example method may also or alternatively be performed by one or more other computing devices. One or more steps of the example method may be rearranged (e.g., performed in a different order), omitted, and/or otherwise modified, and/or other steps added.

FIG. 4A shows, for example, method steps associated with forming and/or updating a scoring model based on played back video segments. In step 410, a plurality of video segments (e.g., video clips) selected by one or more users for output may be received. One or more users (e.g., users of a home security system) may have selected, played back, and/or watched video segments in the past. These video segments and/or the watching history may be tracked (e.g., recorded). The video segments may be received by a computing device which is local and/or remote, for processing. The process of tracking, receiving, and/or processing video segments played back by one or more users may be a start-to-finish and on-going process. For example, tracking user's interest as described above may start as soon as a user watches video clips generated by a camera system (e.g., video camera 126). For example, a user may be presented with demo videos and tested for his/her interest. For example, every time a user selects a video clip to play back, the played back video clip and/or watching history may be used for the process. There may be an initial setting related to user interest. The initial setting may be generated based on user interest surveys and/or statistics, for example, in a relevant geographic and/or demographic area. The initial setting may be generated based on predictions for a relevant user, for example, based on his/her features such as age, gender, career, etc. The initial setting may be used for sorting videos for a new user, before the new user demonstrates any watching habits. For example, the initial setting may correspond to an initial scoring model. The initial setting (e.g., initial scoring model) may be adjusted (e.g., updated) based on video segments received that may reflect the user's current interest or preference.

In step 415, a plurality of characteristics may be determined for each video segment. As described above, video generation characteristics such as camera ID and video characteristics such as objects detected may be obtained using known computer, video analyzing, and/or image recognition technologies.

In step 420, for each characteristic of a plurality of characteristics associated with the plurality of video segments, one or more parameters that reflect user's interest may be determined. For example, a quantity of occurrences of each characteristic may be determined. As described above, a video segment may comprise a plurality of characteristics related to camera, time of generation, content of the video segment, etc. These characteristics may be obtained and/or determined from each video segment and counted for occurrence in more than one video segment. For example, as shown by the table in FIG. 3B, the number of times played back may be obtained from counting the occurrence of each characteristic such as Front door (camera), Morning, Man among a plurality of video segments (e.g., video clips). Each characteristic that appears in a video segment may be counted once. In general, the more a characteristic occurs in played back video segments, the more interest from a user in that characteristic may be shown. For example, in the table in FIG. 3B, numbers of times played back may show that the user may have more interest in video segments generated by the back door camera, compared to other cameras (e.g., the side gate camera).

Length of time played back for each video segment may also reflect user's interest and may be determined. In general, a user may watch a video segment for longer time if he or she has more interest. For example, in the table in FIG. 3B, the longest time played back may show that the user may have more interest in video segments that have animal(s) in the content, compared to other objects (e.g., Child). The counting of the quantity of occurrences and recording the length of time played back may be realized by commonly known computer technologies such as counters and timers.

There may be other parameters that reflect user's interest, for example, number of repeated watching (e.g., if a user watches a same video clip more than once), pause (e.g., if a user pauses a video clip to look at a static image and then resumes playing), zooming in (e.g., if a user enlarges a frame in a video clip to look at details), etc. These parameters may be obtained using known technologies such as video analytics software. Values of these parameters may be incorporated into tables like that in FIG. 3B and may be used in an algorithm for calculating based on weights for the characteristics.

In step 425, a weight may be assigned for each characteristic. As described above (e.g., in connection with FIG. 3B), statistical data (e.g., parameters such as quantities of occurrences of characteristics, length of time played back, etc.) may be processed (e.g., ranked, averaged, finding the total, finding the maximum, etc.) to generate weights which may quantify a user's interest. These weights and corresponding characteristics may form and/or affect at least part of a scoring model which may calculate relevancy scores based on characteristics, weights, and associated algorithms.

In step 430, a scoring model may be updated, for example, based on the plurality of characteristics and the weights. As described above (e.g., in connection with FIGS. 3C and 3E), a scoring model may calculate relevancy scores, for example, using weights and associated algorithms (e.g., sum). There may be an initial scoring model that may be subject to updates. The scoring model may be a separate part (e.g., software). The scoring model may be an integral part of a system (e.g., a home security system). The scoring model may be stored and/or accessed locally and/or remotely. The scoring model may use AI and/or ML technologies to improve accuracy of generated relevancy scores. The scoring model may be a dynamic model that may be updated regularly and/or timely.

In step 435, a determination may be made as to whether a user has provided feedback. A user may provide feedback on the scoring model (e.g., weights, characteristics). The user may be shown at least part of the scoring model and may review and manually change the scoring model. For example, the user may be presented (e.g., through a popup window) with a table listing characteristics and corresponding weights. The user may review the table and manually change one or more of the weights and/or the characteristics. For example, the user may manually remove and/or change uninteresting characteristics. The user may create one or more object detection filters to only detect and/or present objects that are of interest to the user. For example, unwanted objects (e.g., host, wife, own pets, etc.) may be filtered out, for example, by assigning zero, low, or negative weight to them. The user may be able to review and adjust the algorithm, for example, by choosing, removing, adding, and/or revising one or more rules in the algorithm. For example, an original rule may be that zero score is assigned if the wife is in a video clip. The user may change the rule so that weights are summed if an unrecognized person is present besides the wife, for example, if the user suspects that his wife is having an affair. If the user has provided feedback, in step 430, the scoring model may be updated based on user's feedback. If the user does not provide feedback, the scoring model may be ready to be used for a video segment inventory as will be describe below in connection to FIG. 4B.

FIG. 4B shows, for example, method steps associated with applying the scoring model to a video segment inventory for personalizing the arrangement of video segments. In step 440, a video segment inventory including some or all video segments recorded by a plurality of video cameras within one or more designated time frames may be created. For example, the plurality of video cameras may be at least part of a home security system.

In at least some situations, video segments (e.g., video clips) from each video camera may be displayed separately, for example, on different monitors and/or in different windows on a monitor. If a user is forced to browse video segments of each video camera separately, that may cause excessive workload and frustration. In step 440, video segments recorded by each video camera may be retrieved and aggregated, and may form a video segment inventory (e.g., a single list or feed of all motion video segments across all cameras on an account). These video segments may (e.g., in later steps and/or after selection in later steps) be displayed on a single monitor and/or in a single window. The aggregation may be performed based on a user's instructions and/or based on schedules. The one or more designated time frames of recorded video segments may be any time period(s). For example, all video segments within a particular day, several days, a week, a month, and/or any other time period(s) between designated time points. For example, after a user returns from a vacation, he or she may notice some damage to a shed in a backyard. The user may create a video segment inventory for the time period during his/her absence. For another example, a video segment inventory may be created daily to provide timely video feed to a user. For another example, a video segment inventory may be created if one or more highly relevant objects are detected.

In step 445, a plurality of characteristics may be determined for each video segment. As described above in connection with, for example, FIG. 3A, video generation characteristics such as camera ID and part of day, and video characteristics such as objects detected, may be obtained. These characteristics may be inputted to a scoring model as described above. The scoring model may calculate a relevancy score for each video segment, for example, based on the characteristics.

In step 450, a relevancy score may be determined (e.g., assigned) to each video segment, based on the scoring model. As described above in connection with FIG. 3C and FIG. 3E, the relevancy score may be calculated using an algorithm based on the characteristics and their weights. For example, the algorithm may comprise summing the weights. For example, the algorithm may consider assigning a zero score to a video segment if an object detected (e.g., Peter) has zero weight. For example, the algorithm may consider reducing a relevancy score (e.g., to zero) if a corresponding video segment is a duplicate and/or similar one of another video segment, and/or if the video segment has been seen by the user previously. The algorithm may be designed using AI and/or ML technologies so that the relevancy scores may reflect user's interest more accurately. Alternatively or additionally, at least some functions of the algorithm may be performed after the video segment inventory is sorted (e.g., in step 460). For example, duplicate video segments or video segments that have been seen by the user (“previously viewed”) may be identified after video segments are sorted based on relevancy scores, and these video segments may be removed from the sorted inventory. For example, video segments with the lowest relevancy scores may be removed from the sorted inventory.

In step 455, the video segment inventory may be sorted based on relevancy scores. A relevancy score may be a way to quantify an extent to which a user may be interested in a video segment (e.g., video clip). By sorting the video segment inventory based on relevancy scores, for example, in a descending order of relevancy scores, video segments may be positioned in an order of relevancy. As a video segment inventory may be an aggregation of all video segments generated by all video cameras in a given period of time, a user may have an easier and quicker access to the most interesting and/or relevant video segments in an entire camera system (e.g., home security system) without having to review all video segments for each camera.

In step 460, the video segment inventory may be post-processed. As described above in step 450, at least some functions of the algorithm (e.g., duplicate removal) may be performed in step 460. Post-processing the video segment inventory may also comprise steps that may improve storage, transfer, and/or presentation, etc. of video segments, such as video compression, video enhancement, video denoising, etc.

In step 465, at least part of the video segment inventory may be presented. Video segments may be presented in a way that may reflect relevancy ranking. For example, the most relevant video segments may be positioned at the top of a list of video segments. A user may pay more attention to those video segments and less or no attention to less relevant ones at the bottom of the list. For example, most relevant video segments may be highlighted and/or otherwise emphasized. Least relevant video segments may be hidden from view. The video segments may be presented in other ways that are based on the relevancy ranking so that a user may be able to pay attention to the most relevant video segments first.

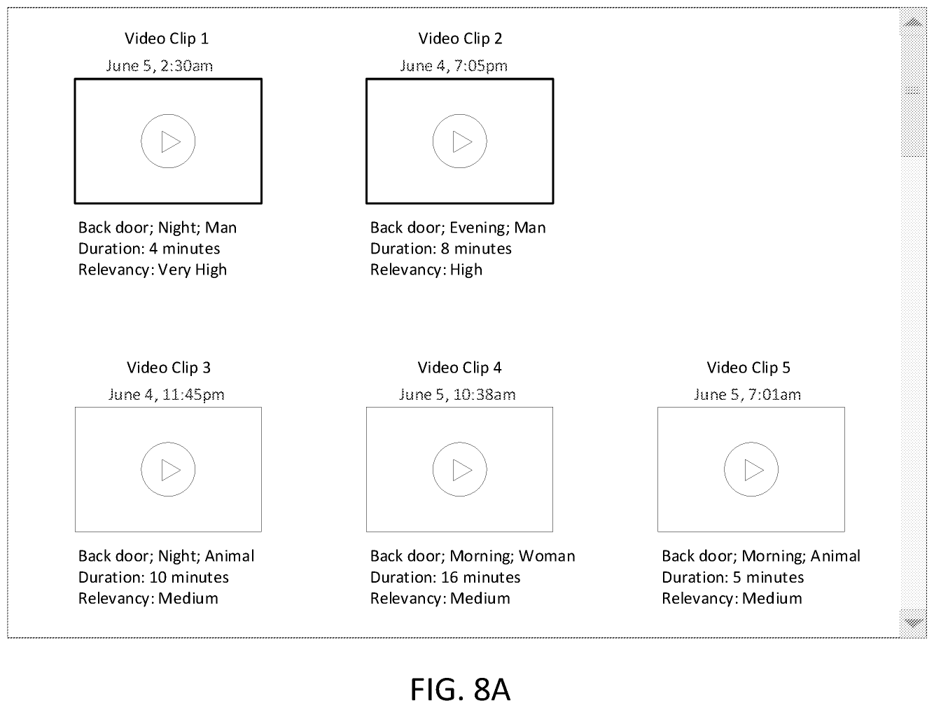

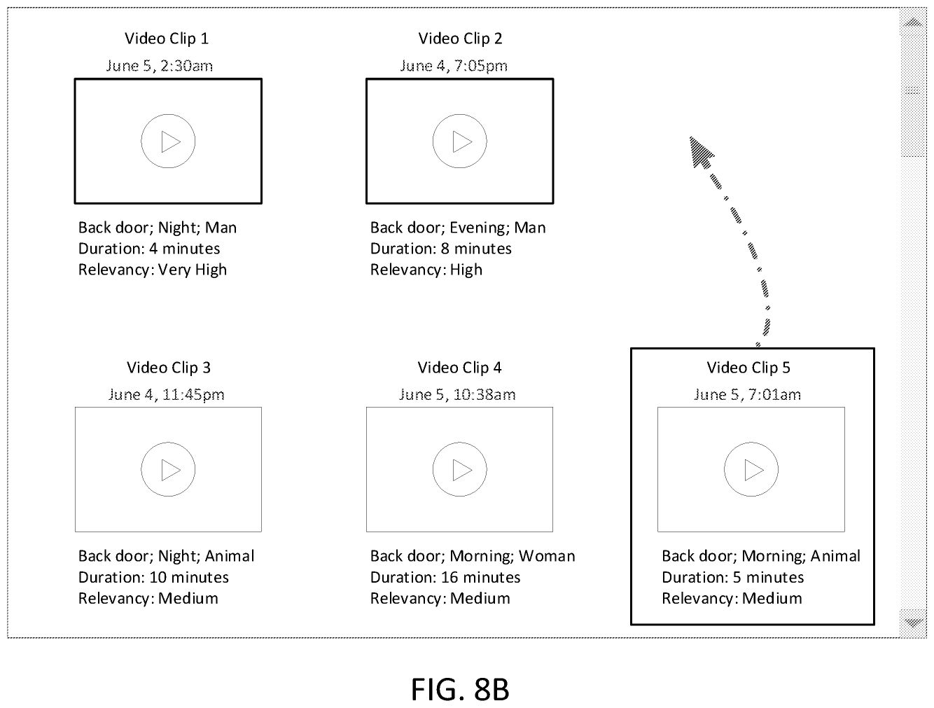

In step 470, a determination may be made as to whether a user has provided feedback. A user may provide feedback based on the presented video segments. The user may provide feedback on the relevancy of any presented video segment. For example, the user may be allowed to change a relevancy level (e.g., from High to Low). For example, the user may be able to change the positions of the video segments (e.g., by moving a video segment to another position in the list, as shown in FIG. 8B). For example, the user may be able to remove video segments that are less relevant. For example, the user may remove or add highlighting to a video segment. If the user has provided feedback, in step 475, the scoring model may be updated based on the feedback from the user. For example, weights may be changed, as described above in connection with FIG. 4A, and the scoring model may be updated based on the changed weights. For example, if a user changed a video segment from a side gate camera with animal at night time in the video from Low relevancy to High relevancy, the scoring model may increase weights for characteristics including Side gate, Animal, Night, etc. The scoring model may have an algorithm for details of weight change, for example, whether and/or how much a weight changes for a characteristic. For example, the algorithm may set one or more thresholds for changing the weights. For example, threshold(s) may be designed so that infrequent and/or random user actions (e.g., due to slight fluctuation of interest, interference of non-major users, etc.) may be ignored. For example, one characteristic may have a higher threshold and/or degree for weight change than another characteristic does. The scoring model may allow the user to review its update and/or to make revisions. If the user does not provide feedback, the example method may continue to perform step 480.

If the scoring model has been updated in step 475, the example method may return to step 450 (and onward) to apply the updated scoring model on current and/or additional video segment inventory. For example, a user may browse through a list of presented video segments and remove a video segment that only shows a spider and web. The scoring model may be updated based on the feedback (e.g., removal of the video segment), and the current video segment inventory may be scored and sorted based on the updated scoring model. The user may be presented with an updated list of video segments which do not contain any spider videos. This timely adjustment may provide the user with better watching experience.

In step 480, a determination may be made as to whether a user has played back any video segment. For example, video APIs (Application Programming Interfaces) may be used to determine if one or more video segments (e.g., video clips) have been played back. If one or more video segments have been played back by the user within a designated time frame (e.g., from a latest time when the video segments are presented to the user), in step 410 (see FIG. 4A), the one or more video segments may be sent to and received by a computing device as described above. The latest played back video segments may be used to keep the scoring model consistent with the latest interest and/or preferences of the user. For example, a user may have played back a video segment at a bottom of a list of video segments and watched for a considerable amount of time. The video segment at the bottom of the list may have a low relevancy score. The action of the user towards this video segment may show that the user may have interest in this video segment. Thus the scoring model may be updated accordingly so that similar videos may have higher relevancy scores and be presented with priority in the future. In a situation where a user both played back and provided feedback (e.g., manually changed relevancy) for a video segment, this video segment may not be sent to the computing device in step 410, and/or an algorithm may intervene so that the scoring model is not repeatedly or excessively updated.

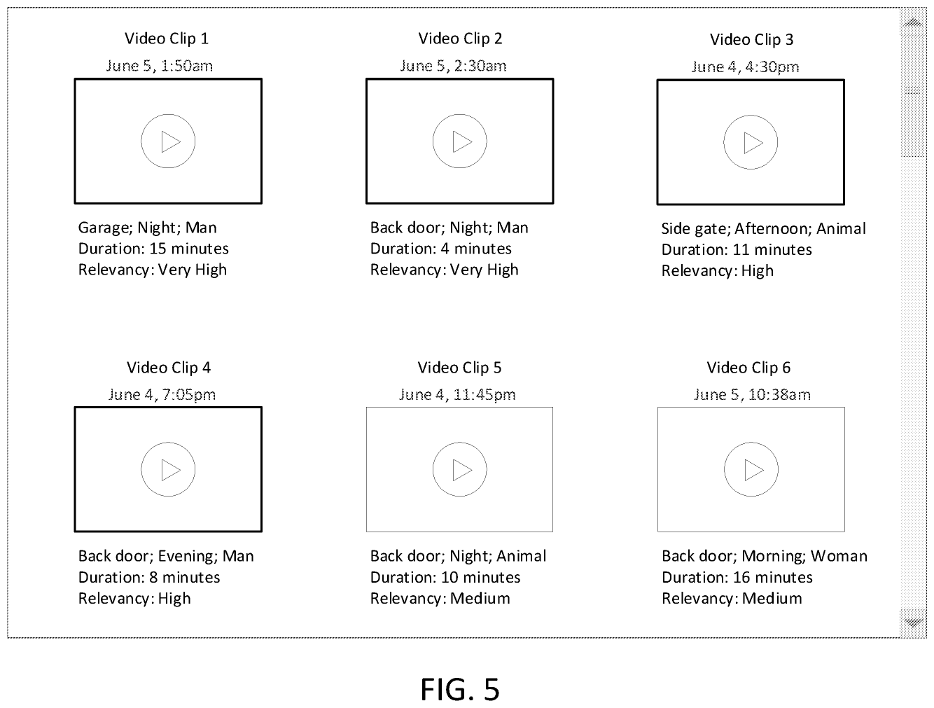

FIG. 5 shows an example of aggregated and personalized presentation for camera feeds of a plurality of video cameras. As described above, video segments (e.g., video clips) from a plurality of video cameras may be aggregated and presented in one view (e.g., on one monitor and/or in one window), so that a user may not need to review video clips from different video cameras separately. For example, in FIG. 5, video clips 1-6 may be from different cameras such as a garage camera, a back door camera, and a side gate camera. Video segments may be arranged (or ordered, prioritized) using methods described above. For example, video segments (e.g., video clips) may be sorted (or ranked) and/or presented, for example, based on relevancy scores. In the example of FIG. 5, video clips 1-6 may be presented in a descending order of relevancy scores. Video clips 1 and 2 may have the highest relevancy scores (e.g., Very High score) among all video clips; video clips 5 and 6 may have medium relevancy scores (e.g., Medium score); and video clips 3 and 4 may have relevancy scores that are below the highest relevancy scores and above the medium relevancy scores (e.g., High score). As a result, a user may see and/or click to watch any one of the top six relevant video clips on the page without any extra effort (e.g., using a scrollbar). Additional video clips (e.g., with lower priority or relevance) may be seen by scrolling downwards. For example, video clips with low relevancy scores may be positioned near a bottom of this page. A user may decide to skip viewing the rest of the page, for example, if the user does not have much time. The user may have peace of mind if skipping the video clips near the bottom, knowing that these video clips may not be very relevant or interesting. A user may choose to be shown only the most relevant (e.g., top n) video clips (e.g., top 10 in relevancy scores). If more than one video clip may have a same relevancy score and/or relevancy level, these video clips may be positioned in a designated order (e.g., in a reverse chronological order, based on duration, etc.). Each video clip may show information including date/time (e.g., timestamp), camera ID, part of day, object detected, duration, etc., in addition to relevancy. The additional information may help a user determine if he or she is interested in watching details of a video clip, without playing the video clip. Each item of the additional information may also be used as basis to sort the video segments (e.g., video clips). For example, video segments may be sorted based on duration. For example, a user may want to see video segments with longest duration first. Video segments may be sorted based on camera ID, so that video segments from the same cameras may be grouped together. Video segments may be sorted based on part of day. Video segments may be sorted based on date/time (e.g., in a reverse chronological order). Video segments may be sorted based on object detected. For example, video segments that contain animals may be grouped together. Video segments with Peter in them may be grouped together. The video segment sorting based on relevancy scores as describe above may be combined with the sorting using any of the items. For example, grouped animal video clips may still be presented in a descending order based on relevancy scores (e.g., with most relevant animal video clips presented first).

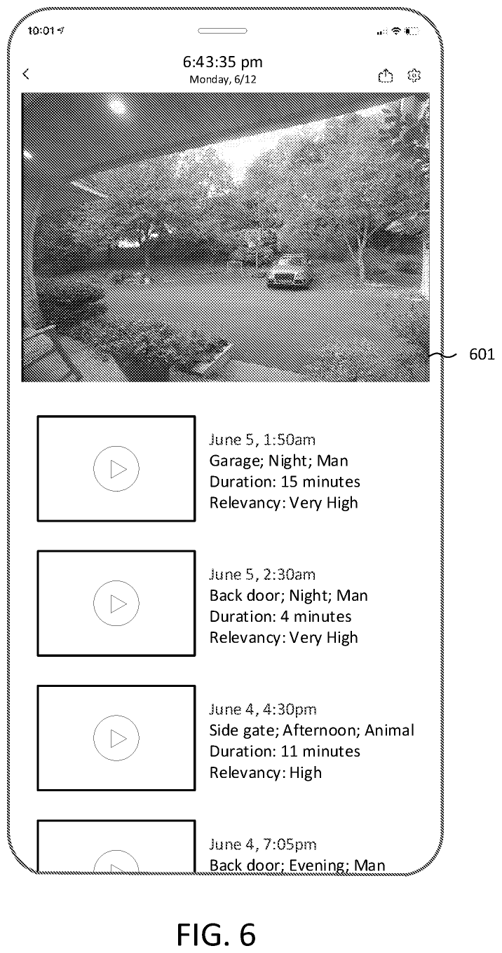

FIG. 6 shows another example of aggregated and personalized presentation for camera feeds of a plurality of video cameras. Aggregated and personalized (e.g., sorted based on relevancy) video segments (e.g., video clips) may be presented in any layout and/or on any display. For example, video segments may be presented on a screen of a mobile device such as mobile phone (e.g., as shown in FIG. 6). In FIG. 6, there may be a list of video clips arranged from top to bottom that may fit the screen of the mobile phone. These video clips may be arranged (or ordered, prioritized) using methods described above. For example, the most relevant video clips may be positioned at the top. Additional video clips (e.g., with lower priority or relevance) may be seen by scrolling downwards. There may also be a video display window 601 that may appear on the screen. The video display window 601 may play any video clips in the list, for example, if a user may click any of the video clip to play. The video display window 601 may display a real time view from a selected camera (e.g., back door camera), for example, as a default setting. A user may use the mobile device to obtain and/or watch relevant video segments at home or remotely, which may provide convenience to the user. The video segments may be provided to the user regularly (e.g., daily, weekly, etc.). The video segments may be provided to the user if one or more conditions are met (e.g., if relevancy satisfies a threshold of High). A user may be alerted if new video segments arrive. A user may be provided with a summary about content of new video segments. A user may receive a special notification with notes if a highly relevant video segment appears.

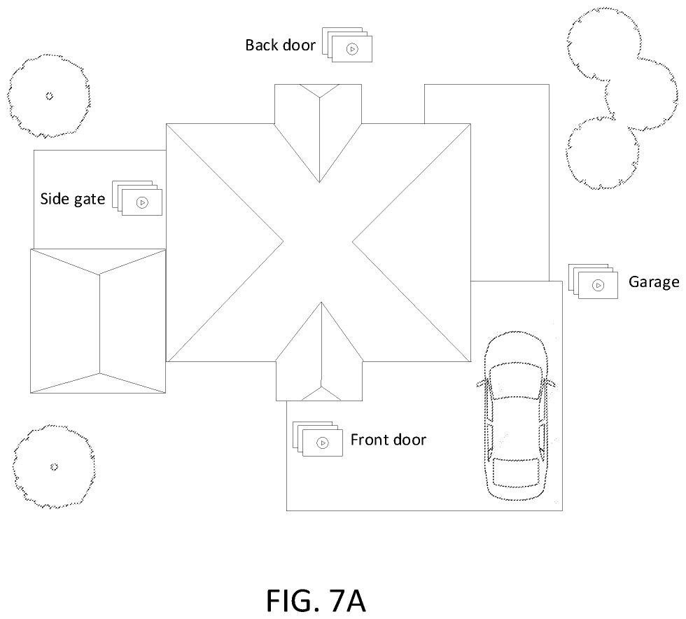

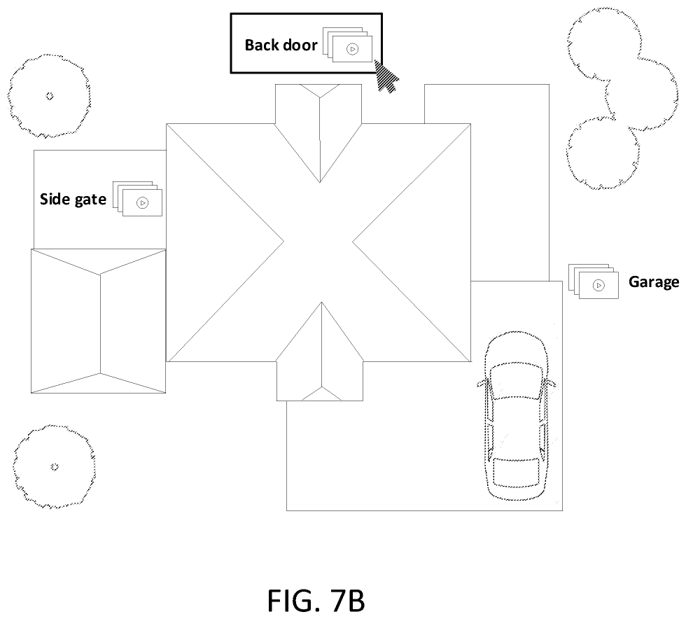

FIG. 7A and FIG. 7B show an example map of a premises with clickable icons for camera feeds. Video segments (e.g., video clips) may be arranged (or ordered, prioritized) using methods described above (e.g., sorted based on relevancy scores), and may be presented in any way that may enhance a user's experience. For example, video segments may be shown on a background of a map and/or plan view, so that a user may intuitively see where top relevant video segments may come from. For example, in FIG. 7A, icons and/or thumbnails of video segments may be displayed at corresponding camera locations. For example, icons and/or thumbnails of video segments from a back door camera may be placed near a back door on the map. The icons and/or thumbnails may be clickable (e.g., as shown in FIG. 7B). A user may click to watch and/or to obtain a detailed list of the video segments at a location. The intuitive display of clickable icons may provide a user with a unified view of activities around the home and a feeling of control, and may make it easier for a user to perform targeted viewing of video segments for different parts of the house. FIG. 7B shows an example of presentation where video segments with lowest relevancy may be hidden from view. For example, video segments from the front door camera may have the lowest relevancy (e.g., lowest relevancy scores). For example, a neighbor's car routinely passing the front door may not be interesting (e.g., alarming) to the user. In FIG. 7B, no icon may be shown near the front door. A user may assume that it had been uneventful near the front door and may give his/her attention to other areas of the house.

FIG. 8A shows an example of personalized presentation for a camera feed. For example, after clicking on the icon in FIGS. 7A and 7B associated with the back door of the premises, a follow-up page as shown in FIG. 8A may appear. Video segments from the back door camera may be arranged (or ordered, prioritized) using methods described above and may be displayed on this page in a descending order based on relevancy. For example, two most relevant video clips (e.g., with relevancy “Very High” and “High”) may appear on a top row on this page. The most relevant video clips may be highlighted to draw attention from a user. Additional video clips (e.g., with lower priority or relevance) may be seen by scrolling downwards. The follow-up page may use any other layout and/or display modes that allow a user to identify, and/or to direct his/her attention to, the most relevant video clips first.

FIG. 8B shows an example of reordering the presentation by a user. The same display from FIG. 8A may be used in FIG. 8B as an example. FIG. 8B shows a way for a user to provide feedback with respect to relevancy. For example, if a user does not agree that video clip 5 (with animal, in the morning, at the back door) is of medium relevancy, the user may provide feedback by manually changing the relevancy of the video clip 5 (e.g., by dragging video clip 5 to a top row where the most relevant video clips are). The user may provide feedback in any other way applicable to an interface. As describe above, the feedback (e.g., change of relevancy) may lead to change of weights and/or the scoring model, and eventually change of outputted video clips. Although not shown, a user may also provide feedback on relevancy in a similar way in the examples of FIGS. 5 and 6.

The camera system may comprise and/or be a part of any system that may use one or more cameras as a substantial functional part, for example, a security system, a monitoring system, an entertainment system, etc. The camera system may be used in any environment, for example, home, office, construction site, factory, roads, outer space, etc. The presentation or interface described/illustrated herein may be part of any application.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

1. A method comprising:
receiving, by a computing device, a first plurality of video segments that were generated by a plurality of video cameras associated with a premises and that were selected by one or more users;
determining, one or more characteristics associated with the first plurality of video segments, wherein the characteristics comprise:
one or more characteristics associated with selection of the plurality of video segments, and
one or more characteristics associated with content of the plurality of video segments;
determining a quantity of occurrences of each of the one or more characteristics;
sorting, based on the determined quantities, a second plurality of video segments generated by one or more video cameras of the plurality of video cameras; and
causing presentation of the sorted second plurality of video segments.

2. The method of claim 1, wherein the characteristics comprise one or more of:
camera ID;
part of day;
categories of motion entities in the content;
derivative categories of motion entities in the content; or
audio categories.

3. The method of claim 1, wherein the causing presentation comprises causing arrangement of the second plurality of video segments based on the sorting.

4. The method of claim 1, wherein the sorting comprises:
sorting the second plurality of video segments based on corresponding relevancy scores, and wherein the method further comprises:
determining weights for the characteristics; and
calculating, based on the weights and a scoring model, the corresponding relevancy scores.

5. The method of claim 1, further comprising:
receiving feedback, based on the presentation, from the one or more users;
updating a scoring model based on the feedback; and
sorting, based on the updated scoring model, a third plurality of video segments generated by one or more video cameras of the plurality of video cameras.

6. The method of claim 1, wherein the sorting comprises:
sorting the second plurality of video segments based on corresponding lengths of time, and
wherein the method further comprises determining, for each characteristic of the one or more characteristics associated with the first plurality of video segments, a length of time of each video segment associated with the characteristic.

7. The method of claim 1, further comprising:
removing, from the second plurality of video segments and prior to the causing presentation, duplicate, previously viewed, and/or low-relevancy video segments.

8. The method of claim 1, wherein the second plurality of video segments comprises a video segment inventory, wherein the method further comprises sorting the video segment inventory, based on the first plurality of video segments.

9. The method of claim 1, wherein the plurality of video cameras comprise video cameras of a security system for the premises.

10. A method comprising:
creating, by a computing device and for a plurality of video cameras associated with a premises, a video segment inventory, wherein the video segment inventory comprises video segments generated by the plurality of video cameras within one or more designated time frames;
determining one or more characteristics associated with each of the video segments, wherein the one or more characteristics are determined based at least on content of the video segments and how the video segments are selected by a user;
assigning, based on the determined characteristics, a relevancy score to each video segment; and
sorting the video segment inventory for presentation based on assigned relevancy scores.

11. The method of claim 10, wherein the sorting comprises lowering relevancy scores for duplicate video segments.

12. The method of claim 10, wherein the characteristics comprise one or more of:
camera ID;
part of day;
categories of motion entities in the content;
derivative categories of motion entities in the content; or
audio categories.

13. The method of claim 10, further comprising:
updating, based on feedback from one or more users associated with the presentation, a scoring model;
re-sorting the video segment inventory, using the updated scoring model; and
causing presentation of at least a portion of the re-sorted video segment inventory.

14. The method of claim 10, further comprising:
updating, based on feedback from one or more users associated with the presentation, a scoring model;
sorting a second video segment inventory using the updated scoring model; and
causing presentation of at least a portion of the sorted second video segment inventory.

15. The method of claim 10, further comprising:
causing presentation of at least a portion of the sorted video segment inventory, via a user interface,
wherein the causing presentation comprises:
arranging, based on the relevancy scores assigned to a plurality of video segments of the at least the portion of the sorted video segment inventory, the plurality of video segments; and
adjusting, based on user input changing the arrangement, one or more of the relevancy scores assigned to the plurality of video segments.

16. The method of claim 10, wherein the plurality of video cameras comprise video cameras of a security system for the premises.

17. A method comprising:
determining, by a computing device and based on user interactions with video segments of a plurality of video segments generated at a plurality of times by a plurality of cameras associated with a premises, relevancies of the plurality of video segments;
determining, based on the relevancies, one or more cameras, of the plurality of cameras, and one or more times, of the plurality of times;
sorting, based on the determined one or more cameras and based on the determined one or more times, subsequent video segments generated by the plurality of cameras; and
generating, based on the sorted subsequent video segments, a presentation of at least a portion of the subsequent video segments.

18. The method of claim 17, further comprising:
determining, based on the relevancies, categories of motion entities in content of the video segments; and
sorting, based on the determined categories of motion entities, the subsequent video segments.

19. The method of claim 17, further comprising:
receiving user feedback for the presentation; and
re-sorting, based on the user feedback, the subsequent video segments.

20. The method of claim 17, wherein the presentation is a single presentation for all the at least a portion of the subsequent video segments.
